(19) United States
(12) Patent Application Publication
(10) Pub. No.: US 2025/0165752 A1
(43) Pub. Date: May 22, 2025

(54) SYSTEMS AND METHODS FOR PROCESSING DATA FOR LARGE LANGUAGE MODELS

(71) Applicant: Infobip Ltd., London (GB)

(72) Inventor: Ivica LOVRIC, Zagreb (HR)

(21) Appl. No.: 18/517,600

(22) Filed: Nov. 22, 2023

(51) Int. Cl. G06N 3/0455; G06N 3/08

(52) U.S. Cl. CPC G06N 3/0455; G06N 3/08

(57) ABSTRACT

A method includes: receiving a query; determining a capability associated with the query using at least one of a capability machine learning model or a segmentation algorithm; determining, using a routing system, a large language model provider, among a plurality of large language model providers, that best matches the capability associated with the query; providing the query to the large language model provider; and receiving a response from the large language model provider.

### TECHNICAL FIELD

Various embodiments of the present disclosure relate generally to systems and methods for processing data for large language models, and, more particularly, to systems and methods for determining a routing path, query, and associated parameters to a large language model provider among a group of large language model providers.

### BACKGROUND

With many large language model providers, each with their own API, user interface, functionalities, fee models, requirements, etc., a user may need to provide a query that is customized to an individual provider, and may not choose the best provider for the query in terms of cost, efficiency, or accuracy, for example.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method including: receiving a query; determining a capability associated with the query using at least one of a capability machine learning model or a segmentation algorithm; determining, using a routing system, a large language model provider, among a plurality of large language model providers, that best matches the capability associated with the query; providing the query to the large language model provider; and receiving a response from the large language model provider.

In some aspects, the techniques described herein relate to a method, further including: checking a request cache; and determining that the query does not match a cached query.

In some aspects, the techniques described herein relate to a method, further including: generating a modified query for the large language model provider.

In some aspects, the techniques described herein relate to a method, wherein the generating the modified query includes: compressing the received query.

In some aspects, the techniques described herein relate to a method, wherein the compressing the received query includes: removing one or more tokens from the query.

In some aspects, the techniques described herein relate to a method, wherein the compressing the received query includes: providing a difference between the received query and the compressed query.

In some aspects, the techniques described herein relate to a method, further including: providing the received response from the large language model provider.

In some aspects, the techniques described herein relate to a method, further including: receiving an updated capability from a large language model provider, among the plurality of large language model providers; and updating the routing system based on the updated capability.

In some aspects, the techniques described herein relate to a method, wherein the determining the large language model provider further includes: determining the large language model provider based on one or more of least cost, fallback, quality, or accuracy.

In some aspects, the techniques described herein relate to a method, wherein the determining the large language model provider further includes determining the large language model provider based on a requested parameter in the query.

In some aspects, the techniques described herein relate to a method, further including: generating an intent based on the query, wherein the determining the large language model provider further includes determining the large language model provider based on the generated intent.

In some aspects, the techniques described herein relate to a method, further including: performing a health check of one or more of the plurality of large language model providers.

In some aspects, the techniques described herein relate to a method, wherein the determining the large language model provider includes determining the large language model provider based on the health check.

In some aspects, the techniques described herein relate to a method including: receiving a query; determining that the query matches a cached query; retrieving a cached response from a large language model provider for the cached query; and providing the cached response.

In some aspects, the techniques described herein relate to a method, wherein the determining that the query matches a cached query includes: determining whether a similarity of the query to the cached query is above a similarity threshold.

In some aspects, the techniques described herein relate to a method, wherein the cached response includes a response generated by: receiving the cached query; determining a capability associated with the cached query using at least one of a capability machine learning model or a segmentation algorithm; determining the large language model provider, among a plurality of large language model providers, that best matches the capability associated with the cached query; providing the cached query to the large language model provider; and receiving the cached response from the large language model provider.

In some aspects, the techniques described herein relate to a method, further including: performing a health check of one or more of the plurality of large language model providers, wherein the determining the large language model provider includes determining the large language model provider based on the health check.

In some aspects, the techniques described herein relate to a system including one or more processors configured to execute a method including: receiving a query; determining a capability associated with the query using at least one of a capability machine learning model or a segmentation algorithm; determining, using a routing system, a large language model provider, among a plurality of large language model providers, that best matches the capability associated with the query; providing the query to the large language model provider; and receiving a response from the large language model provider.

In some aspects, the techniques described herein relate to a system, the method further including: removing one or more tokens from the query.

In some aspects, the techniques described herein relate to a system, the method further including: performing a health check of one or more of the plurality of large language model providers, wherein the determining the large language model provider includes determining the large language model provider based on the health check.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a large language model provider routing system, according to one or more embodiments.

FIG. 2 depicts a flowchart of a method of routing a query to a large language model provider, according to one or more embodiments.

FIG. 3 depicts a flowchart of a method of generating dynamic client exposed API capability based on integrated model capabilities of a large language model provider routing system, according to one or more embodiments.

FIG. 4 depicts a flowchart of a method of routing a query to a large language model provider, according to one or more embodiments.

FIG. 5 depicts a flowchart of a method of analyzing content of a request to a large language model provider routing system, according to one or more embodiments.

FIG. 6 depicts a flowchart of a method of a cache lookup in a large language model provider routing system, according to one or more embodiments.

FIG. 7 depicts a flowchart of a method of compressing a request to a large language model provider routing system, according to one or more embodiments.

FIG. 8 depicts a flowchart of a method of routing a query to a large language model provider, according to one or more embodiments.

FIG. 9 depicts a flowchart of a method for checking health of a large language model provider routing system, according to one or more embodiments.

FIG. 10 depicts a flowchart of another method for checking health of a large language model provider routing system, according to one or more embodiments.

FIG. 11 is a simplified functional block diagram of a computer system that may be configured as a device for executing the techniques disclosed herein, according to one or more embodiments.

FIG. 12 depicts a flow diagram for training a machine learning model, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for processing data for large language models, and, more particularly, to systems and methods for determining a routing path, query, and associated parameters to a large language model provider among a group of large language model providers.

An entity may benefit from receiving a large language model output for a given request. The entity may further benefit from receiving such an output from one or more of a plurality of large language model providers (e.g., based on given attributes or training of the one or more such providers, based on the request, based on the entity, etc.). With many large language model providers, one or more of which with their own API, user interface, functionalities, fee models, requirements, etc., a user may need to provide a query that is customized to an individual provider, and may not choose the best provider for the query in terms of cost, efficiency, and/or availability, for example. One or more embodiments may provide a system to cooperate with many large language model providers, may standardize a query, or input request, and may provide a single access point for users with a standardized API endpoint.

One or more embodiments may receive a query, determine a large language model provider, among a group of large language model providers, that best matches a capability associated with the query, generate a modified query for the large language model provider, and provide the modified query to the large language model provider. One or more embodiments may provide a system with specific optimizations to, for example, reduce tokens in the query, to cache embedding, and/or to provide the modified query to a fallback large language model provider if a first provider does not respond within a threshold time. One or more embodiments may provide a system including an agnostic large language model (LLM) router that connects to multiple LLM providers, and requests a standardized LLM action with one or more preferences or task types. An LLM model as discussed herein may be any applicable LLM such as but not limited to a Language Representation Model, a Natural Language Processor, a Zero-shot Model, a Multimodal Model, a Fine-tuned Model, a Domain-specific Model, a Large Language Model (e.g., Pathways Language Model (PaLM), XLNet, Bidirectional Encoder Representations from Transformers (BERT), Generative pre-trained transformers (GPT), Large Language Model Meta AI (LLaMA), and/or the like. One or more embodiments may provide a system including advanced functionalities such as fallbacks, least cost routing, prompt compressions, and/or prompt caching routing by functionality and/or metric scores representing a competence level of a model.

One or more embodiments may provide a system including smart LLM routing based on one or more of least cost, fallback, best quality, or best accuracy. One or more embodiments may provide a system including smart LLM routing based on a feature requested, including one or more of text generation, language translation, text completion, summarizations, question answering, chatbot functionality, or image generation. One or more embodiments may provide a system including a single integration that simplifies LLM usage by standardizing service input from one or more of queries, usage tracking per use cases or segments, or metrics. One or more embodiments may provide a system that provides cost savings, by implementing one or more of prompt caching and prompt compression.

One or more embodiments may provide a system that provides observability using various metrics, such as cost tracking and savings tracking, for example. One or more embodiments may provide a system that increases an accuracy of a response to a query. One or more embodiments may provide a system that receives feedback from a user regarding the quality of a response to a query. For example, feedback may be received by a client in an additional API request for score submission referring to a prior response correlated by an identifier. Feedback may be submitted for score adjustment without providing a “correct” response and/or for score adjustment by providing a “correct” response.

Feedback may be provided via score alternation. Score alternation may have a tendency to decrease a feedback score. Score alternation may receive only an identifier and score (e.g. in a range from 1-10). For example, score alternation may use a Gompertz function to curb potential extreme score lowering with slowly falling properties. Score alternation may be applied periodically after N number of samples are collected. Score alternation may not change an LLM, but may alter an accuracy score for a reported action. Feedback may be provided via fine tuning. Fine tuning may have a tendency to increase a feedback score. Fine tuning may receive an identifier and a correct answer. Fine tuning may be process intensive relative to score alternation. Fine tuning may be applied periodically after N number of samples are collected. Fine tuning may update an LLM based on the provided correct answers.

One or more embodiments may provide a system that moves external LLM integrations and authentications from multiple services to a single router, while simplifying and unifying a client-side API endpoint. One or more embodiments may provide a system where an end user or service can easily choose an LLM task, by using a flag, for example, without requiring knowledge of particular systems and technologies for LLM providers. One or more embodiments may provide a system where an end user or service can easily track and monitor usage, savings, and other metrics by accessing a single API endpoint. One or more embodiments may provide a system that offers savings to end users by using smart approaches, such as prompt caching, compression, and/or choosing a least cost provider, for example, when querying an LLM provider. One or more embodiments may be used in voice or real-time communication infrastructure.

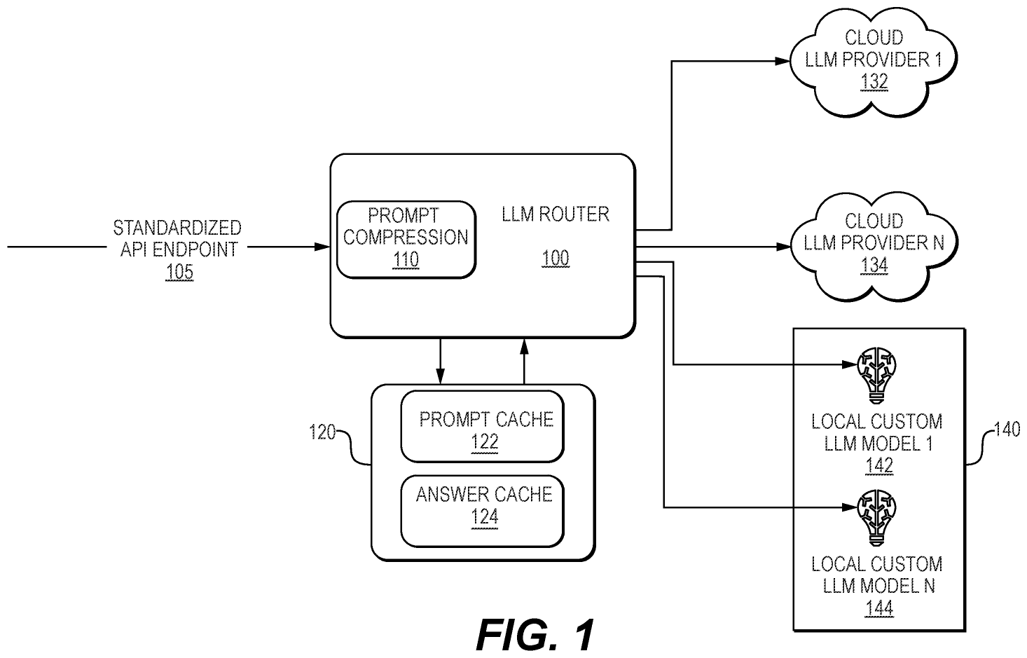

FIG. 1 depicts an exemplary system infrastructure for a large language model provider routing system, according to one or more embodiments. As shown in FIG. 1, a router, or routing system, 100 to a large language model provider may include or communicate with a standardized API endpoint 105 to receive a query. Routing system 100 may include a prompt, or query, compressor 110. Routing system 100 may include or communicate with cache storage 120, first LLM provider 132 (e.g., a cloud LLM provider), second LLM provider 134 (e.g., a cloud LLM provider), and local LLM model 140. Cache storage 120 may include or communicate with prompt, or query, cache 122 and answer cache 124. Local LLM model 140 may include first local LLM model 142 and second local LLM model 144. Although first LLM provider 132, second LLM provider 134, and local LLM model 140 are generally described herein, it will be understood that any applicable number of LLM providers may be applied to embodiments disclosed herein.

Routing system 100 may receive a query via a standardized API endpoint 105, and may compress the received query using query compressor 110 to reduce a number of tokens, such as a number of words, characters, bits, redundancies, etc., for example, in or associated with the query. Compressing the query may include removing one or more tokens from the query. Compressing the query may reduce one or more of storage costs, processing time, or LLM provider costs, for example. Routing system 100 may process one or more of the received query or the compressed query using cache storage 120. Routing system 100 may use cache storage 120 to determine whether the query is similar to (e.g. above a similarity threshold) one or more of a previously received query or a previously compressed query stored in query cache 122, and if so, may retrieve and re-use a previously provided response stored in answer cache 124.

If the received query is not similar to (e.g. below a similarity threshold) a previously received query or a previously compressed query stored in query cache 122, routing system 100 may determine whether to provide (e.g. send) the received query to one or more of first LLM provider 132, second LLM provider 134, first local LLM model 142, or second local LLM model 144. For example, routing system 100 may determine routing based on one or more of least cost, fallback, best quality, or best accuracy. Routing system 100 may determine routing based on a feature requested, including one or more of text generation, language translation, text completion, summarizations, question answering, chatbot functionality, or image generation (e.g., requested as part of or as a supplement to the query).

One or more embodiments may include determining (e.g., extracting) one or more capabilities associated with a query. As used herein, capabilities may include, but are not limited to, a query format (e.g., a question, a pattern request, a trend request, a task request, a summary request, etc.), a sentiment associated with the query, a content type (e.g., image, chart, text, video, audio, etc.), an analysis type (e.g., historical analysis, data analysis, etc.), a computation, and/or the like.

A capability associated with a query may be determined using a capability machine learning model. The capability machine learning model may receive the query as an input and may output one or more capabilities. The capability machine learning model may be trained in accordance with techniques disclosed herein with respect to one or more other machine learning models. For example, the capabilities machine learning model may be trained based on historical or simulated queries and/or historical or simulated capabilities associated with such historical or simulated queries. One or more weights, layers, nodes, synapsis, biases, or weights may be adjusted based on such historical or simulated data that may, for example, be tagged.

Alternatively, or in addition, a query may be segmented using a segmentation model. The query may be segmented based on query structure, terms or content associated with the query, and/or the like. The segmentation model may assign weights to different segments of the query based on predetermined or dynamically determined rules applied to the query. The segmentation model may output a segmentation score for each or a subset of the segments. The segmentation scores for each or all of the segments may be correlated with capabilities such that one or more capabilities with a segmentation score above a given threshold may be associated with the query. As further discussed herein, query capabilities may be matched with one or more LLM model capabilities to select optimal LLM models for the query.

One or more embodiments may include providing the received query as an input to an determination machine learning model trained based on historical or simulated queries, historical or simulated LLM selections, historical or simulated LLM outputs, and/or the like (“determination model training data”). The determination model training data may be applied to a machine learning algorithm to train the determination machine learning mode. The training may include initializing, updating, and or adjusting one or more weights, layers, biases, nodes, synapses or the like of the determination machine learning model based on the determination model training data and/or training algorithm. The determination machine learning model may be configured to receive, as inputs, the received and/or compressed query and may further be configured to receive inputs such as, but not limited to, client information, cached queries, current event information, and or the like. The determination machine learning model may apply one or more of the inputs to output one or more LLM models. For example, the determination machine learning model may apply the inputs to one or more layers, weights, biases, synapses, or nodes to output one or more LLM models.

Alternatively, or in addition, the determination machine learning model may output a determination score associated with all or a subset of available LLM models. The determination score for a given LLM model may be an overall score for the given LLM model. Alternatively, or in addition, the determination machine learning model may output a score for each of one or more categories associated with the query and/or LLM model. For example, the determination machine learning model may output a storage cost score, a processing time score, and/or an LLM provider cost score for each or a subset of the available LLM models. According to this embodiment, routing system 100 may select one or more LLM models based on an overall score or category based scores for each or a subset of the available LLM models. For example, routing system 100 may select one or more LLM models based on such scores and further based on a given client's settings, preferences, prior priorities, or on a given query's attributes or ranking.

For example, an LLM entities model may include:
{
“models”: [
{
   “name”: “GPT-3”,
   “description”: “Generative Pre-trained Transformer 3”,
   “Cost metric”: “token”,
   “Cost”: “0.03”,
   “Average user score”: “X”,
   “capabilities”: [
      “Textgen”,
      “Text generation”,
      “Language translation”,
      “Text completion”,
      “Text summarization”,
      “Question answering”,
      “Chatbot functionality”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
],
“status”: [
   {
      “Reachable”: “true”,
      “Enabled”: “false”
   }
],
   “api_link”: “https://openai.com/gpt-3”
},
{
   “name”: “GPT-4”,
   “description”: “Generative Pre-trained Transformer 4”,
   “Cost metric”: “token”,
   “Cost”: “0.06”,
   “Average user score”: “X”,
   “capabilities”: [
      “Textgen”,
      “Text generation”,
      “Language translation”,
      “Text completion”,
      “Text summarization”,
      “Question answering”,
      “Chatbot functionality”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
],
“status”: [
   {
      “Reachable”: “true”,
      “Enabled”: “true”
   }
   ],
   “api_link”: “https://openai.com/gpt-4”
},
{
   “name”: “BERT”,
   “description”: “Bidirectional Encoder Representations from Transformers”,
   “Cost metric”: “token”,
   “Cost”: “0.03”,
   “Average user score”: “X”,
   “capabilities”: [
      “Natural language understanding”,
      “Text classification”,
      “Named entity recognition”,
      “Text summarization”,
      “Question answering”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
],
“status”: [
   {
      “Reachable”: “true”,
      “Enabled”: “false”
}
   ],
   “api_link”: “https://github.com/google-research/bert”
},
{
   “name”: “ELMo”,
   “description”: “Embeddings from Language Models”,
   “Cost metric”: “token”,
   “Cost”: “0.02”,
   “Average user score”: “X”,
   “capabilities”: [
      “Word embeddings”,
      “Contextualized word representations”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
],
“status”: [
   {
      “Reachable”: “true”,
      “Enabled”: “false”
   }
],
“api_link”: “https://allennlp.org/elmo”
},
{
   “name”: “FastText”,
   “description”: “Library for efficient learning of word representations”,
   “Cost metric”: “token”,
   “Cost”: “0.02”,
   “Average user score”: “X”,
   “capabilities”: [
      “Word embeddings”,
      “Text classification”,
      “Text categorization”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
],
“status”: [
   {
      “Reachable”: “false”,
      “Enabled”: “false”
   }
],
“api_link”: “https://fasttext.cc/”
},
{
   “name”: “XLNet”,
   “description”: “Generalized Autoregressive Pretraining for Language Understanding”,
   “Cost metric”: “token”,
   “Cost”: “0.02”,
   “Average user score”: “X”,
   “capabilities”: [
      “Textgen”,
      “Text generation”,
      “Natural language understanding”,
      “Text classification”,
      “Text completion”,
      “Question answering”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
],
“status”: [
   {
      “Reachable”: “true”,
      “Enabled”: “true”
   }
],
“api_link”: “https://github.com/zihangdai/xlnet”
},
{
   “name”: “GODEL”,
   “description”: “Large-scale pretrained models for goal-directed dialog—Chatbot/Opensource”,
   “Cost metric”: “hour”,
   “Cost”: “0.1”,
   “Average user score”: “X”,
   “capabilities”: [
      “GPU”,
      “Local deployment”,
      “Chatbot functionality”,
      “Question answering”
   ],
“metrics”: [
   {
      “ROUGE”: “XXX”,
      “BLEU”: “XXX”,
      “METEOR”: “XXX”,
      “COMET”: “XXX”,
      “BERT”: “XXX”,
   }
   ],
“status”: [
   {
      “Reachable”: “true”,
      “Enabled”: “false”
   }
],
“api_link”: “https://github.com/microsoft/GODEL”
}
]
}

In response to the provided query, routing system 100 may receive an answer, or response, from one or more of first LLM provider 132, second LLM provider 134, first local LLM model 142, or second local LLM model 144.

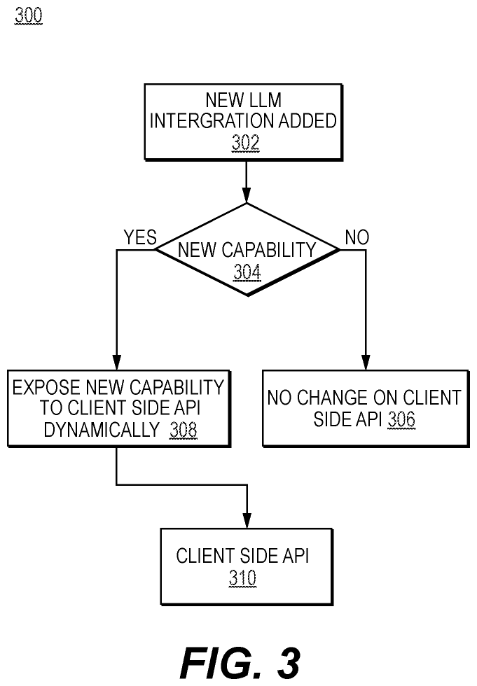

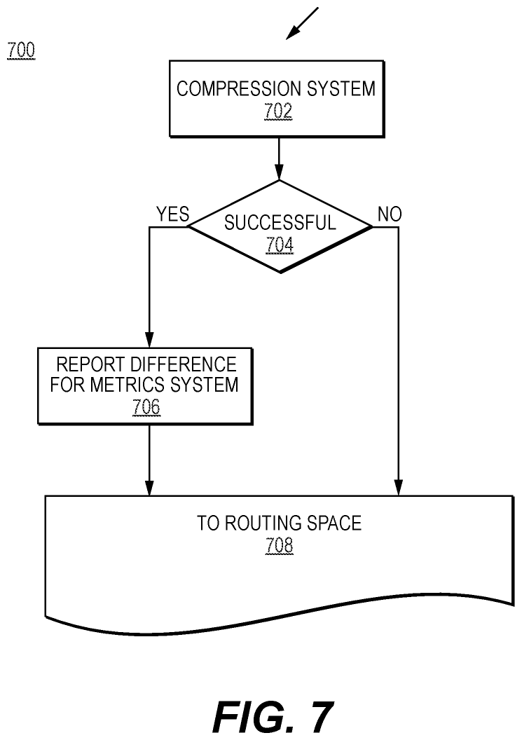

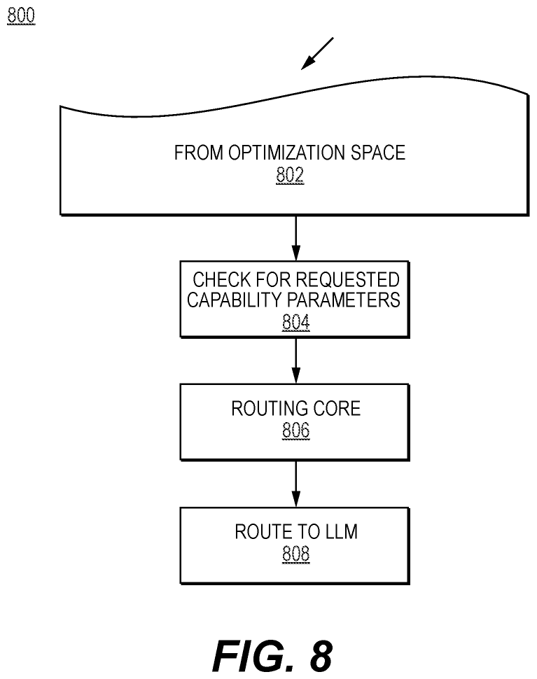

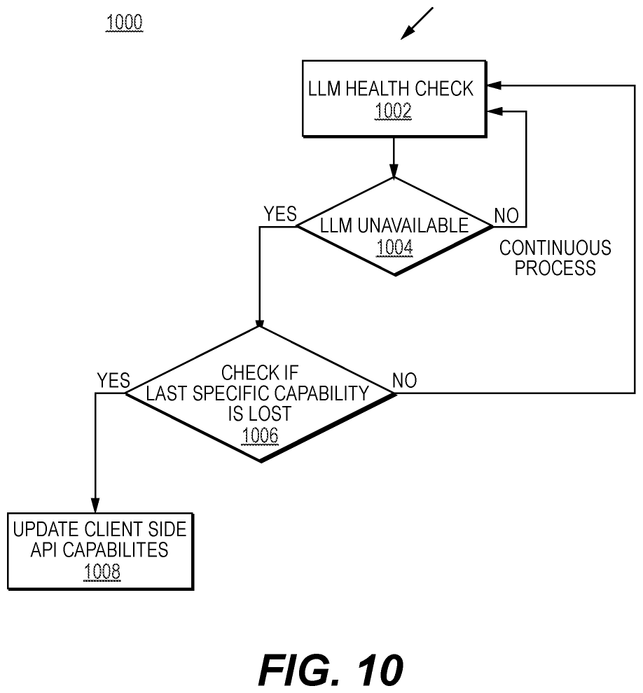

Routing system 100 may provide the response via standardized API endpoint 105. Standardized API endpoint 105 may be updated with current LLM provider capabilities (e.g., see FIG. 3 and/or FIG. 10). Standardized API endpoint 105 may provide a metrics system (e.g., see FIG. 7). Standardized API endpoint 105 may receive requested capabilities (e.g., see FIG. 8), such as in the form of flagged parameters, for example.

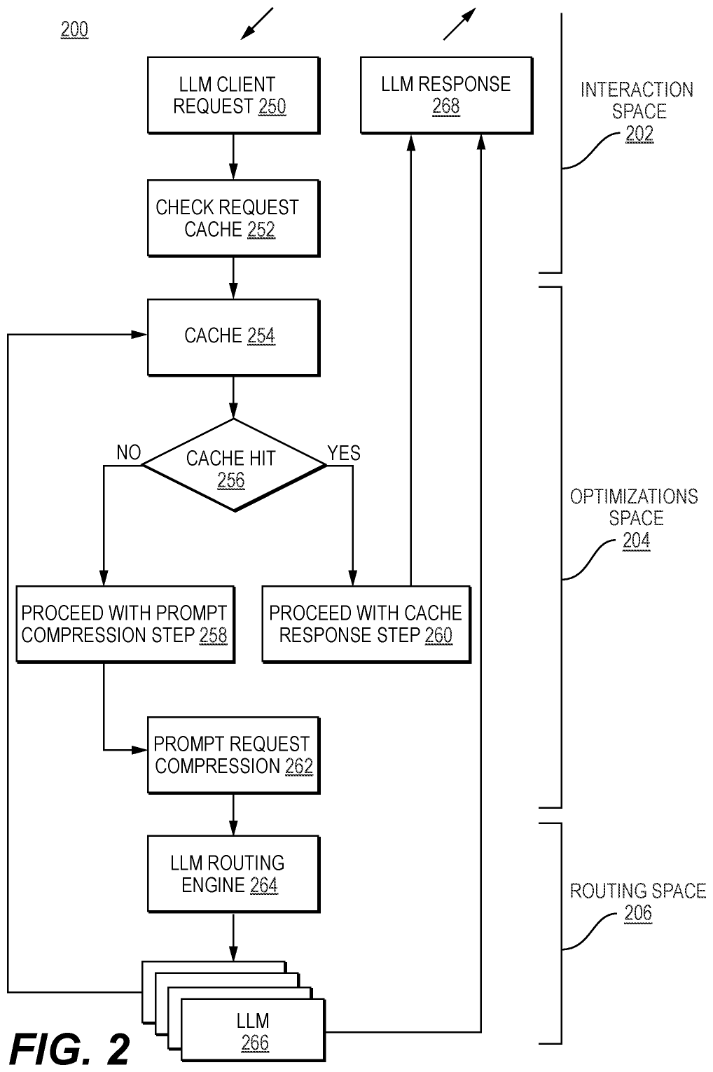

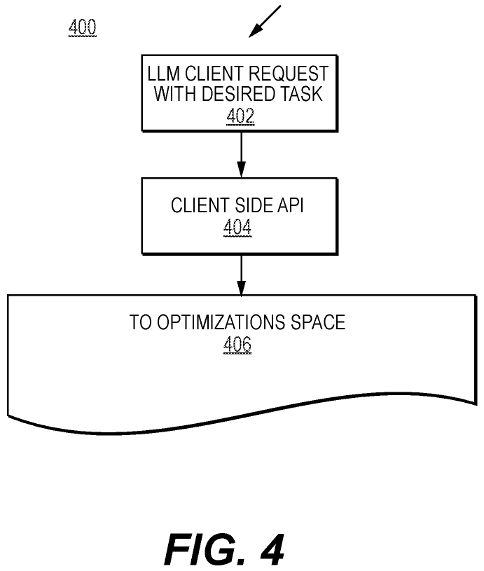

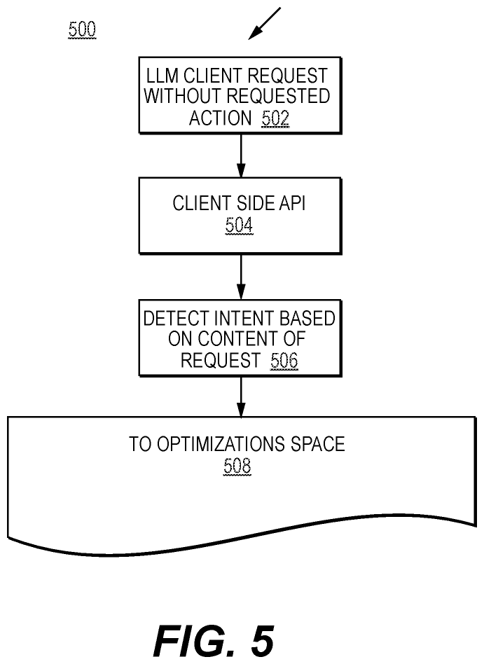

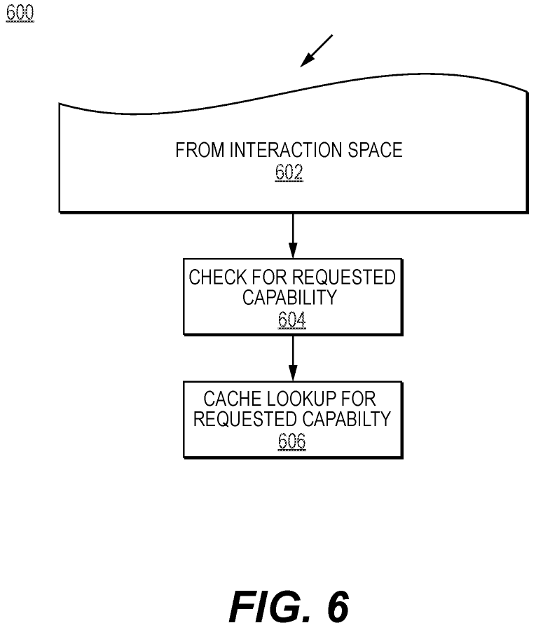

FIG. 2 depicts a flowchart of a method 200 of routing a query to a large language model provider, according to one or more embodiments. Method 200 may describe an operation of routing system 100, for example. Method 200 may include receiving an LLM client request (operation 250) in an interaction space 202, such as via standardized API endpoint 105, for example. For example, a response may be received as an industry-standardized JSON format for transporting data between 2 API endpoints. The LLM client request may include one or more express parameters, such as a parameter to perform a desired function or use a desired LLM provider (e.g., see FIG. 4, FIG. 6, and/or FIG. 8). LLM client request may not include an express parameter (e.g. see FIG. 5).

For example, an API model with request API endpoints and responses may include:
REQUEST:
/ai—main endpoint for LLM actions
{summarize: <Input Text>,
“options”: {“LLM”: <“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
   {qa:<Input Text>, “options”: {“LLM”:<“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
   {similar: <Input Text>, “options”: {“LLM”: <“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
   {sentiment: <Input Text>, “options”: {“LLM”: <“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
   {ner: <Input Text>, “options”: {“LLM”: <“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
   {translate: <Input Text>, “options”: {“LLM”: <“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
   {complete: <Input Text>, “options”: {“LLM”: <“XYZ”|default-auto>, “result”:<accuracy|cost|default-auto>, “randomness”: 0-100,“min_length”: X, “max_length”: X, cache: “true|false|default-true”, compress: simple char replace|method2|method3|default-simple char replace}}
/feedback—endpoint for user feedback
{id, score}—re-scoring
{id, correct answer}—fine-tuning/retraining
/capabilities—List all capabilities for integrated LLM, their capabilities and various standard benchmarks so users can choose exact LLM if they prefer
RESPONSE:
/ai—main endpoint
{id: “id”, response: “LLM response”, routing_info{LLM used, response time, tokens used, compression ratio if enabled . . . }}
/feedback—endpoint for user feedback
{success|fail}
/capabilities

Method 200 may include storing the LLM client request in a temporary buffer (operation 252) such as a check request cache which may be a local or remote database, storage, memory, and/or the like. Method 200 may include accessing a cache (operation 254) which may be a local or remote database, storage, memory, and/or the like. Method 200 may include determining whether the LLM client request in the temporary buffer matches a stored request in cache (operation 256). For example, LLM client request may match a stored request in cache when a similarity between the LLM client request and the stored request is above a similarity threshold. Both requests (a received request and a compressed request) may be stored in persistent database or cache with a relationship, compression ratio, and response, for example. Method 200 may include checking all stored requests (received and compressed). Method 200 may include determining whether the LLM client request in the temporary buffer matches the stored request in cache using a trained machine learning model such as a machine learning model described herein, for example. When the LLM client request matches a stored request in request cache, a response associated with the matched request in request cache may be loaded as a response to LLM client request (operation 260) without sending the LLM client request to an LLM provider.

Alternatively, when the LLM client request does not match a stored request in request cache (i.e., when a similarity between the LLM client request and the stored request is below a similarity threshold), method 200 may include loading the LLM client request in a query compressor (operation 258) in an optimization space 204. The query compressor may compress (e.g., see FIG. 7) the LLM client request (operation 262). Method 200 may include determining a large language model provider, among a group of large language model providers, that best matches a capability associated with the compressed query, and providing (e.g. using an API) the compressed query to the large language model provider (operation 264) in a routing space 206. Method 200 may include determining one or more large language model providers using a trained determination machine learning model, for example.

For example, an API model with request API endpoints and responses may include:
REQUEST:
(endpoints are/ai, /feedback and/capabilities)
   /ai—main endpoint for LLM actions, there is automatic intent detection option and exact action options for ones that want to specify exact operation like “summarize, qa . . . ”
   {auto: “on”|or if no option is given—select “auto mode”, “options”: {randomness″: 0-100,“min_length”: X, “max_length”: X, “cache”: “true|false|default-true”, “compress”: no|simple char replace|method2|method3|default-simple char replace”, “fallback”: “auto|default-off”}}—where “auto” option automatically detects user intent and performs adequate operations and routing
   {summarize: <Input Text>, “options”: {“LLM”: <“XYZ”|default-auto>, “result”:<accuracy|cost|default-balanced>, “randomness”: 0-100,“min_length”: X, “max_length”: X, cache: “true|false|default-true”, compress: no|simple char replace|method2|method3|default-simple char replace”, “fallback”: “auto|default-off”}}
   {qa: <Input Text>, “options”: {“LLM”: <“XYZ”|default-auto>, “result”:<accuracy|cost|default-balanced>, “randomness”: 0-100,“min_length”: X, “max_length”: X, cache: “true|false|default-true”, compress: no|simple char replace|method2|method3|default-simple char replace”, “fallback”: “auto|defaultoff”}}
   {similar: <Input Text>, “options”: {“LLM”: <“XYZ”|default-auto>, “result”:<accuracy|cost|default-balanced>, cache: “true false|default-true”, compress: no|simple char replace|method2|method3|default-simple char replace”, “fallback”: “auto|default-off”}}
   {sentiment: <Input Text>, “options”: {“LLM”: <“XYZ”|default-auto>, “result”:<accuracy|cost|default-balanced>, cache: “true false|default-true”, compress: no|simple char replace|method2|method3|default-simple char replace”, “fallback”: “auto|default-off”}}
   {ner: <Input Text>, “options”: {“LLM”: <“XYZ”|default-auto>, “result”:<accuracy|cost|default-balanced>, cache: “true false|default-true”, compress: no|simple char replace|method2|method3|default-simple char replace”, “fallback”: “auto|default-off”}}
   {translate: <Input Text>, “options”: {“LLM”: <“XYZ”|default-auto>, “result”:<accuracy|cost|default-balanced>, “randomness”: 0-100,“min_length”: X, “max_length”: X, cache: “true|false|default-true”, compress: no|simple char replace|method2|method3|default-simple char replace”, “fallback”: “auto|default-off”}}
   {complete: <Input Text>, “options”: {“LLM”: <“XYZ”|default-auto>, “result”:<accuracy|cost|default-balanced>, “randomness”: 0-100,“min_length”: X, “max_length”: X, cache: “true|false|default-true”, compress: no|simple char replace|method2|method3|default-simple char replace”, “fallback”: “auto|default-off”}}
/feedback—endpoint for user feedback
{id, score}—re-scoring
   {id, correct answer}—fine-tuning/retraining
/capabilities—List all capabilities for integrated LLM, their capabilities and various standard benchmark/score metrics so users can choose exact LLM if they prefer
RESPONSE:
/ai—main endpoint
Response from some text based models
{id: “id”, response: “LLM response”, routing_info{LLM used, response time, tokens used, compression ratio if enabled . . . }} response, for instance, for image or music generation may be image or music with a system response ID
/feedback—endpoint for user feedback
{success|fail}
/capabilities
Example of integrated LLMs with capabilities, metrics, status and so on
{“models”: [{“name”: “GPT-3”, “description”: “Generative Pre-trained Transformer 3”, “Cost metric”: “token”, “Cost”: “0.03”,
“Average user score”: “X”, “capabilities”: [“Textgen”, “Text generation”, “Language translation”, “Text completion”, “Text summarization”, “Question answering”, “Chatbot functionality” ],
“metrics”: [
{
“ROUGE”: “123”,
“BLEU”: “456”,
“METEOR”: “789”,
“COMET”: “999”,
“BERT”: “999”,
}
],
“status”: [{“Reachable”: “true”, “Enabled”: “false” }], “api_link”:
“https://openai.com/gpt-3” },
{“name”: “GPT-4”, “description”: “Generative Pre-trained Transformer 4”, “Cost metric”: “token”, “Cost”: “0.06”,
“Average user score”: “X”,
   “capabilities”: [“Textgen”, “Text generation”, “Language translation”, “Text completion”, “Text summarization”, “Question answering”, “Chatbot functionality”
],
“metrics”: [
{
“ROUGE”: “123”,
“BLEU”: “456”,
“METEOR”: “789”,
“COMET”: “999”,
“BERT”: “999”,
}
],
   “status”: [{“Reachable”: “true”, “Enabled”: “true” }], “api_link”: “https://openai.com/gpt-4” },
{“name”: “BERT”, “description”: “Bidirectional Encoder Representations from Transformers”, “Cost metric”: “token”, “Cost”: “0.03”,
“Average user score”: “X”,
   “capabilities”: [“Natural language understanding”, “Text classification”, “Named entity recognition”, “Text summarization”, “Question answering” ], “metrics”: [
{
“ROUGE”: “123”,
“BLEU”: “456”,
“METEOR”: “789”,
“COMET”: “999”,
“BERT”: “999”,
}
],
“status”: [{“Reachable”: “true”, “Enabled”: “false” }],“api_link”:
“https://github.com/google-research/bert” },

The one or more determined large language models may receive the compressed query and may process the compressed query. The processing may include determining and outputting a response to the compressed query. The response may be generated based on, for example, providing the compressed query or a decompressed version of the compressed query to an LLM machine learning model such as an artificial neural network. The LLM machine learning model may be trained using self-supervised learning, semi-supervised learning, and/or unsupervised learning. According to an example, the LLM machine learning model may repeatedly predict a next token, term, word, or other applicable output based on the input query.

The one or more determined large language model providers may return a response, which may be stored in cache and loaded as a response to the LLM client request (operation 266). Method 200 may include providing one or more of the response from the one or more large language model providers (from operation 266) or the response associated with the matched request from operation 260 (operation 268).

FIG. 3 depicts a flowchart of a method 300 of generating dynamic client exposed API capability based on integrated model capabilities of a large language model provider routing system, according to one or more embodiments. Method 300 may include receiving a notification of capabilities of a large language model provider (operation 302). For example, the notification may be one or more of an indication that a new capability has been added, a list of multiple capabilities of an LLM provider, or a single new capability of an LLM provider. Method 300 may include determining whether the new capability is already accessible by the client side API (e.g. see API example above) (operation 304). When the new capability is determined to already be accessible by the client side API, method 300 may include making no change to the client side API (operation 306). When the new capability is determined to not already be accessible by the client side API, method 300 may include updating the client side API to include the new capability of the LLM provider (operation 308), and providing the updated client side API to users (operation 310).

FIG. 4 depicts a flowchart of a method 400 of routing a query to a large language model provider, according to one or more embodiments. Method 400 may include receiving an LLM client request that includes a desired task (operation 402) and providing an indication of receipt via the client side API (operation 404). The desired task, or intent, may be provided by the user via an interface associated with the client side API or may be automatically generated based on a query (e.g., based on query properties). The interface may include adjustable weighting factors for least cost, best quality, and/or best accuracy, for example. The interface may include selectable LLM providers, for example. Method 400 may include proceeding through the interaction space 202 and optimization space 204 and method 200 with the LLM client request, as shown beginning with operation 252, for example (operation 406).

FIG. 5 depicts a flowchart of a method 500 of analyzing content of a request to a large language model provider routing system, according to one or more embodiments. Method 500 may include receiving an LLM client request that does not include a desired task (operation 502) and providing an indication of receipt via the client side API (operation 504). Method 500 may include detecting a desired intent of the LLM client request based on a content of the LLM client request (operation 506). For example, LLM client request may be “provide a summary using ACME LLM with a funny style,” a first intent may be detected as “use ACME LLM,” and a second intent may be detected as “funny style.” Method 500 may include detecting the desired intent (see example API above) of the LLM client request using a trained machine learning model such as one or more machine learning models described herein, for example. For example, automatically detecting intent and named entities may depend on an end-user following concise input guidelines. Method 500 may include proceeding through interaction space 202 and optimization space 204 and method 200 with the LLM client request, as shown beginning with operation 252, for example (operation 508).

FIG. 6 depicts a flowchart of a method 600 of a cache lookup in a large language model provider routing system, according to one or more embodiments. Method 600 may include receiving an LLM client request in interaction space 202 (operation 602). Method 600 may include checking whether a requested capability in the LLM client request is available in multiple LLM providers (operation 604). Method 600 may include checking whether a requested capability in the LLM client request is available in cache (operation 606). For example, a cache may store capabilities and standardized metric scores in a database or as a standard-based JSON text object.

FIG. 7 depicts a flowchart of a method 700 of compressing a request to a large language model provider routing system, according to one or more embodiments. Method 700 may include compressing an LLM client request (operation 702). Method 700 may include compressing an LLM client request using a trained machine learning model such as one or more machine learning models described herein, for example. Method 700 may include determining whether the compression was successful (operation 704). When the compression is determined to be unsuccessful, method 700 may include proceeding through routing space 206 and method 200 with the uncompressed LLM client request, as shown beginning with operation 264, for example (operation 708). When the compression is determined to be successful, method 700 may include reporting a difference (e.g. between tokens, where a token may be one or more of a word, a group of words, punctuation, or part of a word) between the uncompressed LLM client request (i.e. the request as received) and the compressed LLM client request to an integrated or separate metrics system (operation 706). According to ChatGPT LLM tokenizer, some general rules of thumb for defining tokens are: 1 token˜=4 chars in English. 1 token˜=3/4 words”. For example, a token may be defined as described in https://deepchecks.com/5-approaches-to-solve-llm-token-limits/, which is incorporated herein by reference. For example, the metrics system may provide one or more of usage, cost tracking, or savings tracking. Method 700 may include proceeding through routing space 206 and method 200 with the compressed LLM client request, as shown beginning with operation 264, for example (operation 708).

FIG. 8 depicts a flowchart of a method 800 of routing a query to a large language model provider, according to one or more embodiments. Method 800 may include receiving an LLM client request in optimization space 204 (operation 802). Method 800 may include checking whether a requested parameter in the LLM client request is available in multiple LLM providers (operation 804). Method 800 may include determining a large language model provider, among a group of large language model providers, which best matches a capability associated with the requested parameter (operation 806). The determination may be based on an overall determination score or one or more category based determination scores, as described herein. Method 800 may include routing the LLM client request to the large language model provider, among a group of large language model providers, which best matches a capability associated with the requested parameter (operation 808).

For example, a user may request a sentiment response/analysis by invoking an/ai endpoint with options:
Defaults for sentiment analysis option:
{sentiment: <Input Text>, “options”: {“LLM”: <“XYZ”|default-auto>, “result”:<accuracy|cost|default-balanced>, cache: “true false|default-true”, compress: simple char replace|method2|method3|default-simple char replace}}
>>> CLIENT REQUEST—GET/ai
{sentiment: “High quality pants. Very comfortable and great for sport activities.
Good price for nice quality! I recommend to all fans of sports” options”: {
“result”:accuracy, compress: no}}
<<<Response
{id: 1234567890, response: “{Positive: 99.1%}”, routing_info{“twitter-roberta-base-sentiment-latest”, 1000 ms, 33, compressio ratio: none used}}

For example, an internal process may include: (1) tag request with random ID tag, (2) select LLMs with capability=sentiment, (3) check if to use cache or not as requested by client—if none provided, default is use cache for this combination of LLM/capabilities, (4) check to use Compression or not as requested by client—if none is provided default is compress with minimal loss, (5) select LLM by metric score (Client selected accuracy in options so select one LLM with metric that describes best accuracy for this capability), (6) forward client's request to selected LLM, (7) receive LLM response, (7) respond to Client that requested this action along with same ID.

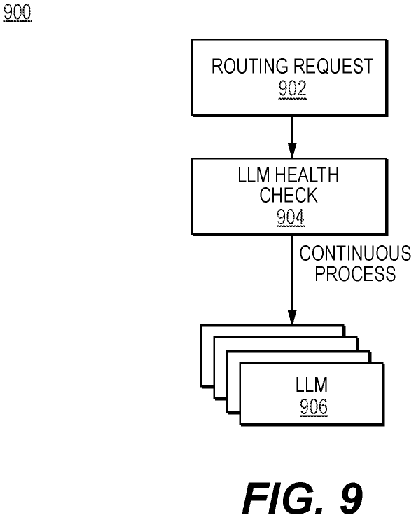

FIG. 9 depicts a flowchart of a method 900 for checking health of a large language model provider routing system, according to one or more embodiments. Method 900 may include receiving an LLM client request along with a routing request (operation 902). Method 900 may include performing a health check of the large language model provider associated with the routing request (operation 904). For example, a health check may include an API endpoint for an LLM with a response of “OK” or “NOT OK” with an optional description for a “NOT OK” response. For example, method 900 may provide the modified query to a fallback large language model provider if a first provider does not respond quickly (e.g. within a threshold time). Method 900 may include providing the LLM client request to the large language model provider (operation 906).

FIG. 10 depicts a flowchart of another method 1000 for checking health of a large language model provider routing system, according to one or more embodiments. Method 1000 may include performing a health check of a plurality of large language model providers (operation 1002). Method 1000 may include determining whether a large language model provider is unavailable (operation 1004). In operation 1004, when the large language model provider is determined to be available, method 1000 may include periodically performing the health check of the plurality of large language model providers in operation 1002. In operation 1004, when the large language model provider is determined to be unavailable, method 1000 may include checking whether a capability of the large language model provider has changed (operation 1006). In operation 1006, when a capability of the large language model provider is determined not to have changed, method 1000 may include periodically performing the health check of the plurality of large language model providers in operation 1002. In operation 1006, when a capability of the large language model provider is determined to have changed, method 1000 may include updating the client side API with the changed capabilities of the large language model provider (operation 1008). For example, method 1000 may include querying available capabilities of a list in a back-end system of all integrated LLMs. When a capability of an LLM is determined to change, the LLM may be removed from the list of LLMs having the capability. Method 1000 may check whether any LLMS remain for the capability. If no LLMs remain with the capability, method 1000 may remove the capability option from the client side API, and if LLMs remain with the capability, the capability set that is exposed the client side API stays the same.

Accordingly, embodiments disclosed herein are directed to improving LLM technology. In accordance with these embodiments, a client may be able to utilize one or more of a plurality of LLM models most applicable to a client query. The one or more of the plurality of LLM models may be identified in a cost and resource efficient manner by matching queries to applicable LLM models. A plurality of available LLM models may be filtered such that only applicable LLM models are used to respond to a given query. Such filtering and LLM model determination makes use of a multiple LLM model system faster than conventional techniques. For example, embodiments disclosed herein allow for faster query response using applicable LLM models rather than a trial and error system.

In general, any process or operation discussed in this disclosure may be computer-implementable, such as the system illustrated in FIG. 1 and/or processes illustrated in FIGS. 2-10, and may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices. One or more processors of a computer system may be included in a single computing device or distributed among a plurality of computing devices. A memory of the computer system may include the respective memory of each computing device of the plurality of computing devices.

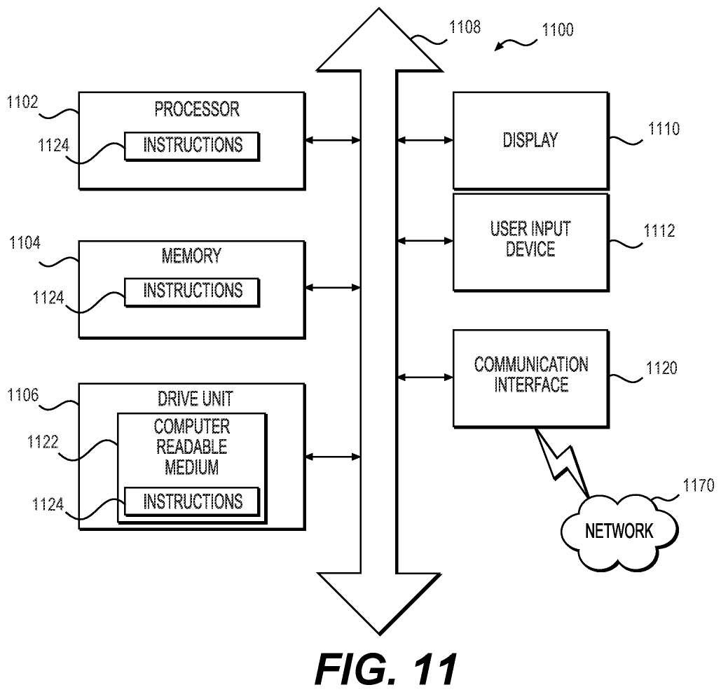

FIG. 11 is a simplified functional block diagram of a computer system 1100 that may be configured as a device for executing the techniques disclosed herein, according to exemplary embodiments of the present disclosure. Computer system 1100 may generate features, statistics, analysis, and/or another system according to exemplary embodiments of the present disclosure. In various embodiments, any of the systems (e.g., computer system 1100) disclosed herein may be an assembly of hardware including, for example, a data communication interface 1120 for packet data communication. The computer system 1100 also may include a central processing unit (“CPU”) 1102, in the form of one or more processors, for executing program instructions 1124. The computer system 1100 may include an internal communication bus 1108, and a storage unit 1106 (such as ROM, HDD, SDD, etc.) that may store data on a computer readable medium 1122, although the computer system 1100 may receive programming and data via network communications (e.g., over a network 1170). The computer system 1100 may also have a memory 1104 (such as RAM) storing instructions 1124 for executing techniques presented herein, although the instructions 1124 may be stored temporarily or permanently within other modules of computer system 1100 (e.g., processor 1102 and/or computer readable medium 1122). The computer system 1100 also may include input and output ports 1112 and/or a display 1110 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

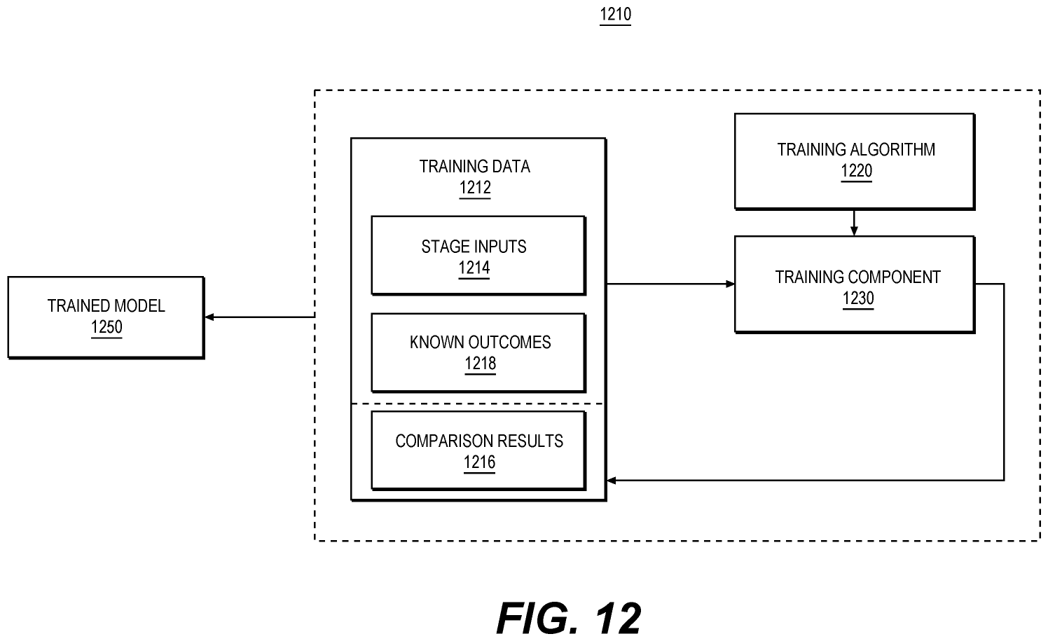

As disclosed herein, one or more implementations disclosed herein may be applied by using a machine learning model. A machine learning model as disclosed herein may be trained using one or more components or operations of FIGS. 1-10. As shown in flow diagram 1210 of FIG. 12, training data 1212 may include one or more of stage inputs 1214 and known outcomes 1218 related to a machine learning model to be trained. The stage inputs 1214 may be from any applicable source including a component or set shown in the figures provided herein. The known outcomes 1218 may be included for machine learning models generated based on supervised or semi-supervised training. An unsupervised machine learning model might not be trained using known outcomes 1218. Known outcomes 1218 may include known or desired outputs for future inputs similar to or in the same category as stage inputs 1214 that do not have corresponding known outputs. A process of fine-tuning LLMs that can be fine-tuned may be described by some form of unsupervised machine learning where feedback responses that are providing correct answer are fed to a fine-tuning process. That process may encompass a small percentage (e.g. from approximately 15% to approximately 20%) of received feedback responses to be checked by humans to be sure that no intentionally wrong answers are being fed to the system and to have some form of human in the loop. An additional process that may involve machine learning may be intent and/or action detection when using the service in an “auto” mode.

The training data 1212 and a training algorithm 1220 may be provided to a training component 1230 that may apply the training data 1212 to the training algorithm 1220 to generate a trained machine learning model 1250. According to an implementation, the training component 1230 may be provided comparison results 1216 that compare a previous output of the corresponding machine learning model to apply the previous result to re-train the machine learning model. The comparison results 1216 may be used by the training component 1230 to update the corresponding machine learning model. The training algorithm 1220 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

One or more embodiments may provide an LLM or any Gen-AI request routing according to competence levels and capabilities. One or more embodiments may provide automatic intent detection for routing without knowing anything about any LLM or any Gen-AI capabilities. One or more embodiments may provide a feedback loop to rescore or fine-tune LLMs based on client feedback. One or more embodiments may provide automatic client API reconfiguration based on integrated LLM or Gen-AI model capabilities.

While the presently disclosed methods, devices, and systems are described with exemplary reference to transmitting data, it should be appreciated that the presently disclosed embodiments may be applicable to any environment, such as a desktop or laptop computer, a mobile device, a wearable device, an application, or the like. In addition, the presently disclosed embodiments may be applicable to any type of Internet protocol.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method comprising:
receiving a query;
determining a capability associated with the query using at least one of a capability machine learning model or a segmentation algorithm;
determining, using a routing system, a large language model provider, among a plurality of large language model providers, that best matches the capability associated with the query;
providing the query to the large language model provider; and
receiving a response from the large language model provider.

2. The method of claim 1, further comprising:
checking a request cache; and
determining that the query does not match a cached query.

3. The method of claim 1, further comprising:
generating a modified query for the large language model provider.

4. The method of claim 3, wherein the generating the modified query includes:
compressing the received query.

5. The method of claim 4, wherein the compressing the received query includes:
removing one or more tokens from the query.

6. The method of claim 4, wherein the compressing the received query includes:
providing a difference between the received query and the compressed query.

7. The method of claim 1, further comprising:
providing the received response from the large language model provider.

8. The method of claim 1, further comprising:
receiving an updated capability from a large language model provider, among the plurality of large language model providers; and
updating the routing system based on the updated capability.

9. The method of claim 1, wherein the determining the large language model provider further includes:
determining the large language model provider based on one or more of least cost, fallback, quality, or accuracy.

10. The method of claim 1, wherein the determining the large language model provider further includes determining the large language model provider based on a requested parameter in the query.

11. The method of claim 1, further comprising:
generating an intent based on the query,
wherein the determining the large language model provider further includes determining the large language model provider based on the generated intent.

12. The method of claim 1, further comprising:
performing a health check of one or more of the plurality of large language model providers.

13. The method of claim 12, wherein the determining the large language model provider includes determining the large language model provider based on the health check.

14. A method comprising:
receiving a query;
determining that the query matches a cached query;
retrieving a cached response from a large language model provider for the cached query; and
providing the cached response.

15. The method of claim 14, wherein the determining that the query matches a cached query includes:
determining whether a similarity of the query to the cached query is above a similarity threshold.

16. The method of claim 14, wherein the cached response includes a response generated by:
receiving the cached query;
determining a capability associated with the cached query using at least one of a capability machine learning model or a segmentation algorithm;
determining the large language model provider, among a plurality of large language model providers, that best matches the capability associated with the cached query;
providing the cached query to the large language model provider; and
receiving the cached response from the large language model provider.

17. The method of claim 16, further comprising:
performing a health check of one or more of the plurality of large language model providers,
wherein the determining the large language model provider includes determining the large language model provider based on the health check.

18. A system comprising one or more processors configured to execute a method including:
receiving a query;
determining a capability associated with the query using at least one of a capability machine learning model or a segmentation algorithm;
determining, using a routing system, a large language model provider, among a plurality of large language model providers, that best matches the capability associated with the query;
providing the query to the large language model provider; and
receiving a response from the large language model provider.

19. The system of claim 18, the method further including:
removing one or more tokens from the query.

20. The system of claim 18, the method further including:
performing a health check of one or more of the plurality of large language model providers, wherein the determining the large language model provider includes determining the large language model provider based on the health check.
